(19) United States
(12) Patent Application Publication
(10) Pub. No.: US 2026/0094091 A1
(43) Pub. Date: Apr. 2, 2026

(54) DYNAMICALLY DIRECT WORKLOAD EXECUTION LOCATION BASED ON QUALITY OF SERVICE

(71) Applicant: DELL PRODUCTS, LP, Round Rock, TX (US)

(72) Inventors: Balasingh Samuel, Round Rock, TX (US); Jacob Mink, Cedar Park, TX (US)

(21) Appl. No.: 18/904,439

(22) Filed: Oct. 2, 2024

(51) Int. Cl. G06Q 10/0631

(52) U.S. Cl. CPC G06Q 10/06315; G06Q 10/06316

(57) ABSTRACT

An information handling system that includes a processor and a memory coupled to the processor. The information handling system may receive data inputs from a plurality of computing monitors. The information handling system may also generate a heat map based on the data inputs from the computing monitors, and the heat map is generated according to a first element and a second element. In addition, the information handling system may determine whether to route execution of a workload within an information handling system or to an external computing device based on the heat map as indicated by a value at an intersection of the first element and the second element. Further, the information handling system may also route the execution of the workload to either within the information handling system or the external computing device according to the value at the intersection.

### FIELD OF THE DISCLOSURE

The present disclosure generally relates to information handling systems, and more particularly relates to dynamically direct workload execution location based on quality of service.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system that includes a processor and a memory coupled to the processor. The information handling system may receive data inputs from a plurality of computing monitors. The information handling system may also generate a heat map based on the data inputs from the computing monitors, and the heat map is generated according to a first element and a second element. In addition, the information handling system may determine whether to route execution of a workload within an information handling system or to an external computing device based on the heat map as indicated by a value at an intersection of the first element and the second element. Further, the information handling system may also route the execution of the workload to either within the information handling system or the external computing device according to the value at the intersection.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a distributed system of information handling systems for dynamically direct workload execution location based on quality of service, according to an embodiment of the present disclosure;

FIGS. 2, 3, and 4 are flowcharts of methods for dynamically direct workload execution location based on quality of service, according to an embodiment of the present disclosure;

FIGS. 5A, 5B, 5C, and 5D are diagrams of data inputs, according to an embodiment of the present disclosure;

FIGS. 6A and 6B are diagrams of heat maps for dynamically direct workload execution location based on quality of service, according to an embodiment of the present disclosure; and

FIG. 7 is a block diagram of an information handling system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

In today's work environment, employees infrequently visit office buildings. Cubicles, desks, and their accompanying computer equipment can be thus shared by different employees in a hoteling arrangement. The cubicles or desks at the office buildings typically have a docking station where an employee can connect to his laptop. The docking station may be fitted with neural processing unit (NPU) capabilities. In addition, some employees may also have a docking station at their homes. However, other locations, such as a corridor or a café may not have such capabilities. Accordingly, a fixed workload distribution system, such as executing the workload within the box, near the box, far from the box, or at a cloud may not be optimal. A dynamic workload distribution that determines where to execute the workload may be advantageous.

Employees may have different working styles. For example, some employees are corridor warriors while others are hybrid employees. An employee who is a corridor warrior typically works inside the organization's building but spends his or her time away from an assigned desk. For example, the employee may work in a meeting room, a café, a corridor, etc. At other times, the corridor warrior may not be assigned a desk. With this type of working style, frequently transferring execution of a workload between the employee's information handling system and a docking station may cause unnecessary data transfer and network traffic affecting quality of service (QoS). QoS may refer to the use of technology or mechanisms to manage and/or control network traffic to ensure optimal workload execution performance.

A hybrid employee typically works from both home and office. At the office, this type of employee typically works at an assigned desk using a docking station. However, at home the employee works at multiple locations, such as a home office, a patio, etc. As such, it may be better to conserve power and computing resources by minimizing the transfer of the workload. For example, workloads with intensive power and computing requirements may be scheduled to run when this type of employee connects his information handling system to a docking station.

In a distributed computing environment, in which a user's workloads may execute locally on a user's information handling system or remotely, such as on a connected computing device, another information handling system, or on a cloud resource, one of the key opportunities for improving user experience is a latency of the workloads including artificial intelligence (AI) workloads. When a user is working on their computer, the latency of the workload may be too high to feasibly run the workload locally. If the user is connected to a local external computer or device, that may be the next best place to run the workload. Thus, the employee's different work styles may affect workload latency. Accordingly, to address the aforementioned issues among others, the present disclosure provides a system and method to dynamically direct workload execution location based on QoS.

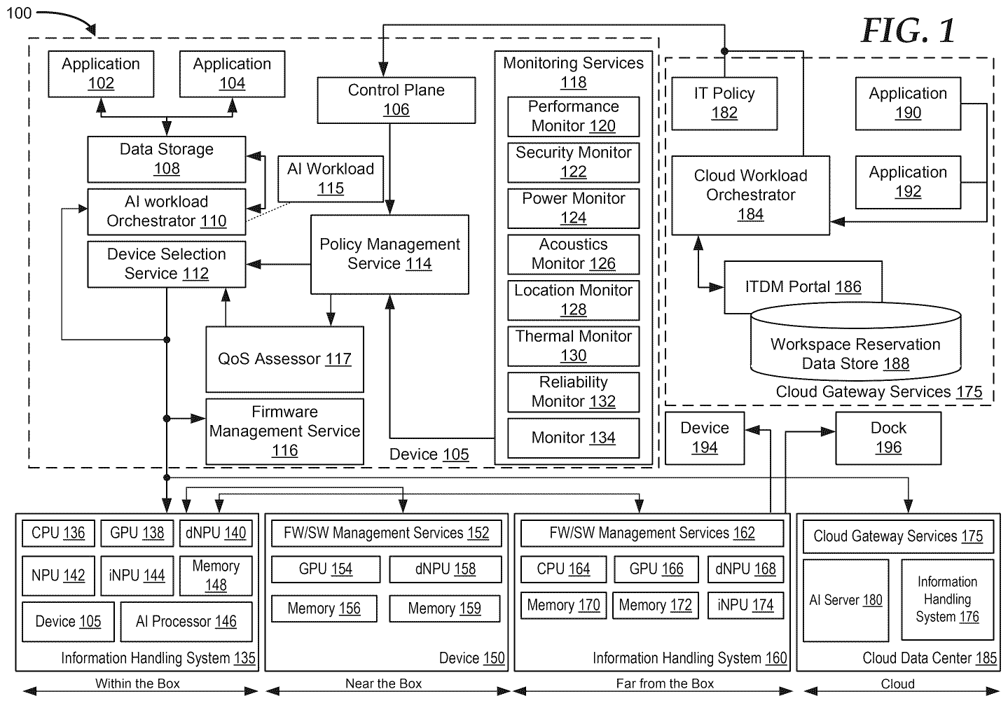

FIG. 1 illustrates a portion of a distributed system environment 100 for dynamically direct workload execution location based on QoS, according to an embodiment of the present disclosure. Distributed system environment 100 includes a set of communicatively coupled information handling systems or compute devices, such as information handling systems 135 and 160, a device 150, and a cloud data center 185. Local and remote information handling systems in distributed system environment 100 may be communicatively linked either by hardwired data links, wireless data links, or a combination of hardwired and wireless data links through a network.

The network may be a public network, such as the Internet, a physical private network, a wireless network, a virtual private network, or any combination thereof. The network may be implemented as or may be implemented as or may be a part of, a storage area network, a personal area network, a local area network, a metropolitan area network, a wide area network, a wireless local area network, an intranet, or any other appropriate architecture or system that facilitates the communication of signals, data, and/or messages.

Information handling systems generally process, compile, store, and/or communicate information or data for business, personal, or other purposes thereby allowing users to take advantage of the value of the information. A continually growing number of information handling systems and devices are being enhanced with AI services, such as heuristic learning, machine learning, deep learning, reinforcement learning services, and the like. Currently, most AI services are performed in central processing units (CPUs), graphics processing units (GPUs), system on chips (SOCs), neural processing units (NPUs), or other processors of the information handling system.

As the number of AI services increases, so will the need for computing resources to execute machine learning or AI models. Nevertheless, executing AI services in the information handling system, such as on-the-box (OTB) can inadvertently affect end-user productivity and negatively exhibit adverse effects, such as reduced battery life, system performance, and overall end-user experience. Conventional techniques to address this problem include AI hardware accelerators and AI software accelerators. However, these accelerators can be busy performing other tasks. In addition, these accelerators can be expensive and thus may not get integrated into low-cost platforms. Accordingly, embodiments of the present disclosure provide a system and method for preemptive and secure transitioning of AI workload to a premium information handling system, such as a docking station using workspace reservation information. In one example, information handling system 135 may be a client computing device, such as an employee's corporate laptop that he or she docks into a docking station upon arrival at a cubicle. The employee may also dock information handling system 135 into a docking station at his or her home.

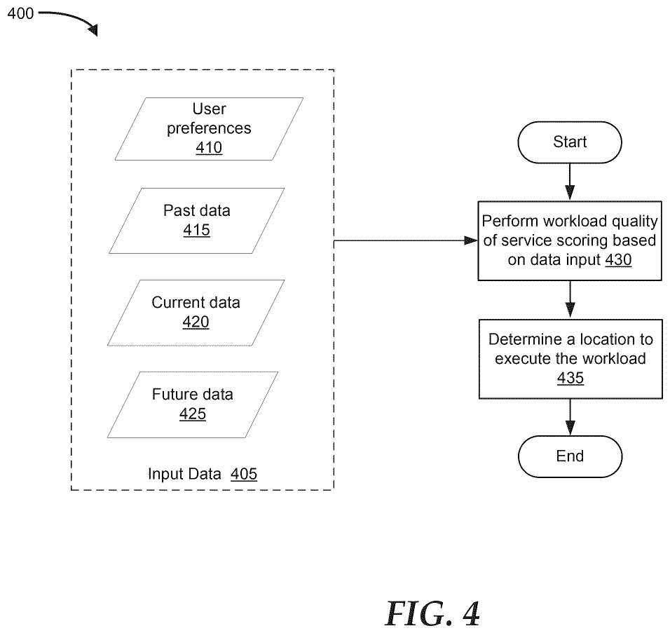

Information handling system 135, which is similar to information handling system 700 of FIG. 4 may be a personal computer, a desktop computer system, a laptop computer system, a server computer system, a mobile device, a tablet computing device, a personal digital assistant, a consumer electronic device, an electronic music player, an electronic camera, an electronic video player, a wireless access point, a network storage device, or any other suitable computing device. Information handling system 135 may also be a portable information handling system that may include a laptop, a notebook, a smartphone, a tablet, or a personal digital assistant, among others.

Information handling system 135 may be communicatively coupled to device 150 and information handling system 160. Information handling system 135 may also be communicatively coupled to cloud data center 185 via the Internet. In this example, information handling system 160 is communicatively coupled with a device 194 and a dock 196. Device 194 may be similar to device 105 while dock 196 may be similar to device 150. However, any variety of connections between various components of distributed system environment 100, such as connections between information handling systems 135 and 160, devices 105 and 194, and dock 196 with cloud data center 185 are envisioned as falling within the scope of the present disclosure. In addition, connections between components and within the various components of distributed system environment 100 are also envisioned as falling within the scope of the present disclosure. In addition, connections between components and within the various components may be omitted for descriptive clarity.

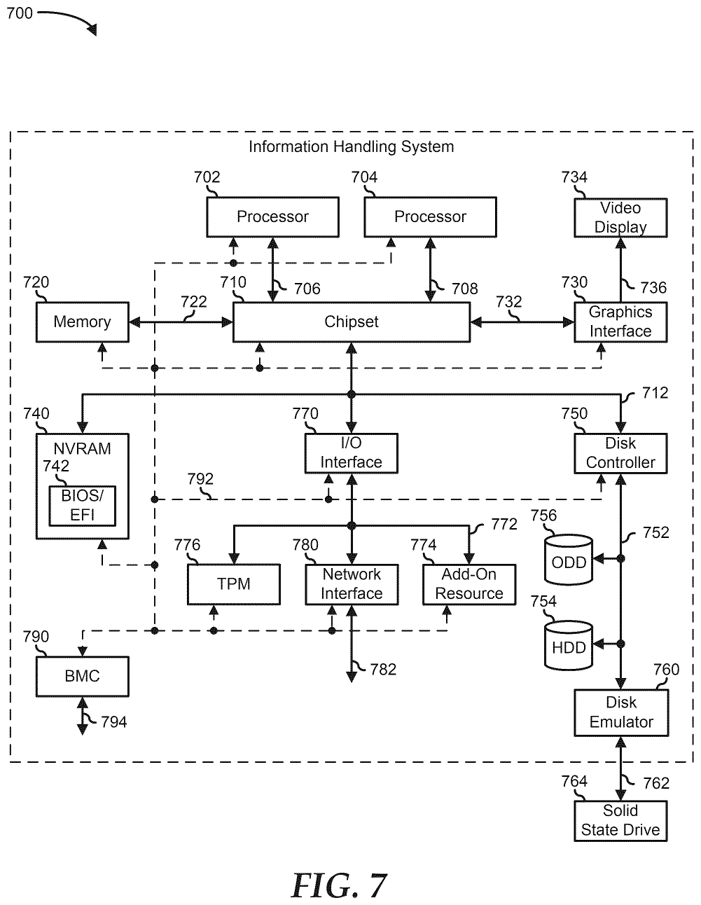

Information handling system 135 includes a device 105, a CPU 136, a GPU 138, a discrete NPU (dNPU) 140, an NPU 142, an integrated NPU (iNPU) 144, an AI processor 146, and a memory 148. CPU 136, which is similar to processors 702 and 704 of FIG. 7, may be configured to execute instructions of an application, such as applications 102 and 104. CPU 136 may also be configured to execute instructions associated with an AI workload orchestrator 110, a device selection service 112, a policy management service 114, a firmware management service 116, and a QoS assessor 117. In addition, CPU 136 along with GPU 138, dNPU 140, NPU 142, INPU 144, and AI processor 146 may be configured to execute an AI workload, such as AI workload 115.

GPU 138, which may be similar to a graphics adapter 730 of FIG. 7, may comprise any system, device, or apparatus configured to process graphical or visual content and to communicate that content to a monitor or display where the content may be rendered. An NPU may comprise any system, device, or apparatus, such as a hardware accelerator that is designed for AI and ML tasks. NPUs are optimized to handle the complex computations required by deep learning algorithms. This optimization makes NPUs efficient at processing AI tasks, such as natural language processing, image analysis, and more. NPUs utilized by information handling system 135 may be of various types including dNPU 158, iNPU 144, and AI processor 146. DNPU may be a discrete NPU, such as an NPU in a USB stick. An NPU may also be integrated with information handling system 135. INPU 144 may be connected via an m.2 slot within information handling system 135. AI processor 146 may comprise any system, device, or apparatus configured to process AI workloads.

Memory 148, which is similar to a memory 720 of FIG. 7, may comprise a non-volatile memory accessible by CPU 136, GPU 138, dNPU 140, NPU 142, INPU 144, device 105, or AI processor 146. However, each one of the aforementioned may be associated with a separate non-volatile memory device. Memory 148 may include a static random access memory (SRAM), a dynamic random access memory (DRAM), or any suitable device to support high-speed memory operations. In certain embodiments, memory 148 may combine both persistent, non-volatile memory and volatile memory. In certain embodiments, memory 148 may include multiple removable memory modules.

Device 105 includes a control plane 106, a data storage 108, AI workload orchestrator 110, device selection service 112, policy management service 114, firmware management service 116, QoS assessor 117, and applications 102 and 104. Applications 102 and 104 are applications installed locally on device 105, also referred to as OTB applications. For example, application 102 may be a video telephony software program while application 104 may be a natural language processing application.

Control plane 106 may be configured to control or route data received from cloud gateway services 175 to one or more components of information handling system 135, such as policy management service 114. In one example, control plane 106 may route IT policy 182 to device selection service 112. Data storage 108 may be a persistent data storage device. Data storage 108 may include solid-state disks, hard disk drives, magnetic tape libraries, optical disk drives, magneto-optical disk drives, compact disk drives, compact disk arrays, disk array controllers, and/or any computer-readable medium operable to store data. Data storage 108 may include a database or a collection of files that is a central repository of data associated with workloads that are accessible by AI workload orchestrator 110 and applications 102 and 104. For example, AI workload orchestrator 110 and applications 102 and 104 may retrieve, store, and utilize data stored in data storage 108.

AI workload orchestrator 110 may be configured to monitor, control, and/or manage AI workloads instantiated using a CPU, GPU, NPU, or similar, such as AI workload 115. AI workload 115 generally refers to data associated with an AI service that is to be performed to generate one or more inferences based on the data. For example, AI workload 115 may include a set of data input, also referred to herein as “input data”, such as telemetry data, past profile recommendations, machine learning hints from other AI services, etc., that may be processed to generate one or more inferences. As such, AI workload 115 may include machine learning and deep learning workloads, such as tasks performed by AI systems which typically involve processing large amounts of data and performing complex computations.

For example, a typical machine learning workflow may include building a model from a sample dataset, evaluating the model against one or more additional sample datasets to decide whether to keep the model and to benchmark how good the model is, using the model in production to make predictions or decisions against live input data captured by an application. The training set, validation set, and/or test set can respectively include pairs of input datasets and output datasets that correspond to the respective input datasets.

Device selection service 112 may comprise any system, device, or apparatus configured to determine a physical and/or virtual device or information handling system to process or transition an AI workload according to a policy, such as IT policy 182. For example, device selection service 112 may determine whether to transition AI workload 115 to a trusted device or information handling system within distributed system environment 100 that includes an AI processor capable of executing an AI workload. An AI processor includes a GPU, CPU, NPU, dNPU, iNPU, or similar that is capable of executing an AI workload. Typically, an OTB AI processor is prioritized over a “near the box” device or information handling system. However, the “near the box” device or information handling system is generally prioritized over a “far from the box” device or information handling system. Accordingly, the “far from the box” AI processor or information handling system is generally prioritized over a cloud resource.

Device selection service 112 and/or AI workload orchestrator 110 may gather data or information from monitoring services 118 or its components. The data or information may include current performance, power utilization, and acoustic and thermal levels, among others to characterize the current state or utilization of one or more components of information handling system 135. This information may be utilized to determine whether to offload AI workloads according to policy, such as IT policy 182 provided by policy management service 114. Policy management service 114 may comprise any system, device, or apparatus configured to manage, monitor, and/or control IT policies, such as policies associated with AI workload transitions.

Firmware management service 116 may comprise any system, device, or apparatus configured to communicate with relevant hardware post-device selection. For example, firmware management service 116 may interface with a specific vendor application programming interface (API) to an OTB hardware, to a hardware connected to information handling system 135, or it may pass through to external components in order to run the workload.

QoS assessor 117 may comprise any system, device, or apparatus configured to generate a heat map that may be used to dynamically direct workload execution location based on QoS metrics. An example of a workload includes an application, a collection of micro-services, artificial intelligence, machine learning, etc. Because workloads may be instantiated and may operate while consuming at least a portion of computing resources, it is desirable that workloads be executed at a location that will minimize its impact on QoS metrics that affect the user.

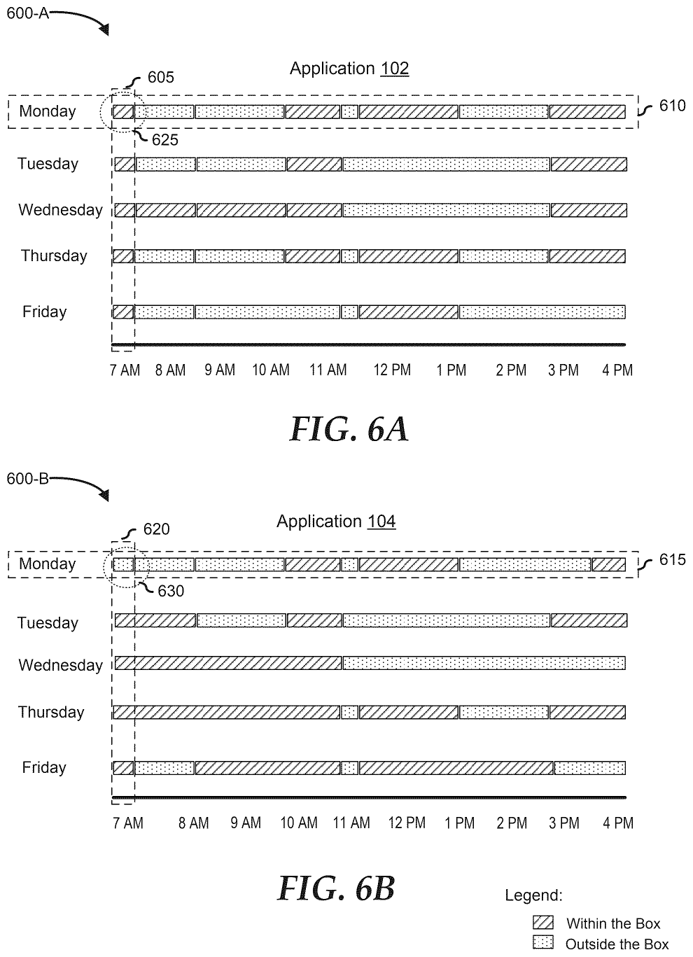

QoS assessor 117 may be configured to generate the heat map based on a user's computer activity during a work day according to the user's working style, such as whether the user has a hybrid, corridor warrior, etc. When generating the heat map, QoS assessor 117 may use data from various inputs, such as the user's outlook calendar, internet protocol address, mobility status (i.e., fixed or mobile), corporate profile, geographic location, network speed, etc. QoS assessor 117 may also use signals from various sensors or monitors, such as from monitoring services 118. A unique heat map may be generated for each type of workload, such as based on a workload identifier. For example, a first heat map may be generated for application 102 as shown in FIG. 6A, and a second heat map may be generated for application 104 as shown in FIG. 6B.

The heat map may be displayed to the user, which allows the user to process the visual information in order to provide feedback and/or preference. As such, the heat map may be updated based on the user's feedback and/or preferences, such as via a questionnaire prompted by a notification center of QoS assessor 117. For example, the heat map may show that application 102 can use information handling system 135 to execute its workload at noon every work day. However, the user can provide feedback or vote to offload the execution of the workload instead. In one embodiment, the request for the user's feedback may be triggered in real time prior to the execution of the workload. In another embodiment, the request for the user's feedback may be provided periodically, such as at a beginning of each work day or work week. Executing the workload “within the box” may refer to executing the workload using information handling system 135. Executing the workload “outside the box” may refer to executing the workload in another device, information handling system, or the cloud associated with distributed system environment 100.

Monitoring services 118 may be configured to monitor, control, and/or manage one or more features of information handling system 135 and/or device 105, such as the health and performance of device 105. As such, monitoring service 118 includes one or more monitoring services, wherein each monitoring service may monitor, control, and/or manage a feature of device 105. For example, monitoring service 118 includes a performance monitor 120, a security monitor 122, a power monitor 124, an acoustics monitor 126, a location monitor 128, a thermal monitor 130, a reliability monitor 132, and monitor 134. Monitoring services 118 can include other monitors or monitoring services than depicted herein as new information becomes available to information handling system 135 and/or monitoring services 118.

Performance monitor 120 may be configured to monitor, manage, and/or control the performance of device 105 and/or its components. For example, performance monitor 120 can collect performance metrics over time, at specified intervals, and generate logs that can be analyzed to identify system performance issues. Security monitor 122 may be configured to monitor, manage, and/or control security of device 105 and/or its components. For example, security monitor 122 can detect a security data threat with data associated with workload. Power monitor 124 may be configured to monitor, manage, and/or control power consumption of device 105 and/or its components. For example, power monitor 124 may determine the power consumption of each one of applications 102 and 104. Acoustics monitor 126 may be configured to monitor, manage, and/or control the acoustics level of device 105 and/or its components. For example, acoustics monitor 126 may provide a current acoustics level to performance monitor 120.

Location monitor 128 may comprise any system, device, or apparatus configured to determine the location and movement of information handling system 135, such as based on triangulation of network information or information accessible via the operating system, or a location subsystem, such as a global positioning system (GPS) module. Thermal monitor 130 may be configured to monitor, manage, and/or control thermal level of device 105 and/or its components. For example, thermal monitor 130 may receive temperature information from one or more temperature sensors. In addition, thermal monitor 130 may provide a current thermal level to performance monitor 120.

Reliability monitor 132 may comprise any system, device, or apparatus configured to monitor, manage, and/or control hardware or software issues that may affect the performance and reliability of information handling system 135. Monitor 134 may comprise any system, device, or apparatus configured to determine other information to be utilized by monitoring services 118 during the monitoring, managing, and/or controlling information handling system 135 and/or its components. For example, monitor 134 may be configured to support proximity sensors, including optical, infrared, and/or sonar sensors, which may be configured to provide an indication of a user's presence near information handling system 135, absence from information handling system 135, and/or distance from information handling system 135, such as near-field, mid-field, or far-field.

In general, computer networks are considered to be trusted according to the following rules: a. by default, provisioned information handling systems under the purview of an organization's information technology (IT) department are trusted by each other for many corporate information handling system users, and b. by default multiple systems registered with the same account are considered to be trusted for non-corporate users. IT administrators have the ability to create smaller groups within their organization, such as engineering laptops workstations, desktop computers, and based on the organization's policy on potential data sharing. Additionally, AI workload processes may consume a relatively large amount of processing resources, yet the results they provide often do not require instantaneous implementation, such as other process-intensive services. On certain conditions and based on the local resources, it could otherwise be better to send the data to another device or a trusted information handling system within an organization group with the capability to perform AI workloads, such as devices with “premium” AI capabilities like device 150. A premium device may include a dock, an M.2 connected NPU, a webcam, or similar that includes an AI processor.

Device 150 may be referred to as a “premium” device with AI processing capabilities that can be utilized to process an AI workload, such as a firmware/software (FW/SW) service 152, a GPU 154, a dNPU 158, and memories 156 and 159. Device 150 may be a dock or docking station, wherein information handling system 135 can be connected, such as via a wired connection or a short-range wireless connection like Bluetooth®. Wi-Fi®, NearLink®, near-field communication (NFC), low-power wide-area network, ultra-wideband, Institutes of Electrical and Electronics Engineers (IEEE) 802.15, or similar. As such, device 150 may be a trusted device and classified as a “near the box” system relative to information handling system 135. In addition, physical devices or peripherals that are plugged in or associated with device 150 or other information handling systems that are physically or wirelessly connected to information handling system 135 via a short-range wireless connection may also be classified as “near the box” devices or information handling systems. This includes a webcam, keyboard, monitor, or other devices that are connected to information handling system 135 and/or device 150.

FW/SW management service 152 may comprise any system, device, or apparatus configured to communicate with the relevant information handling system post-selection. For example, FW/SW management service 152 may interface with a device, component, or information handling system that will be leveraged on the device itself in order to run the AI workload. Accordingly, FW/SW management service 152 may be configured to receive an AI workload, run the AI workload locally, and then return the result to the source or display the result to the user. For example, FW/SW management service 152 may communicate via APIs to another information handling system, component, device, or to a cloud workload orchestrator, such as cloud workload orchestrator 184. In another example, FW/SW management service 152 may communicate with AI workload orchestrator 110.

GPU 154, which is similar to GPU 138, may comprise any system, device, or apparatus configured to process graphical or visual content and to communicate that content to a monitor or display where the content may be rendered. DNPU 158 may be similar to dNPU 140. Device 150 may include other AI processing units, also referred to as AI processors, similar to NPU 142, iNPU 144, and AI processor 146. Memories 156 and 159 may be similar to memory 148. In one embodiment, memory 156 may be accessible by GPU 154 while memory 159 may be accessible by dNPU 158. However, GPU 154 and dNPU 158 may also be configured to share one memory.

Information handling system 160 can be a physical or virtual computing device that includes an FW/SW management service 152, a CPU 164, a GPU 166, a dNPU 168, and memories 170 and 172. Information handling system 160 may also be coupled to device 194 and dock 196, which is similar to device 105 and device 150 respectively. In one embodiment, distributed system environment 100 may include a trusted workgroup that is configured in a trusted peer network. The trusted workgroup may include information handling systems 135 and 160, and device 150, wherein these information handling systems and devices may be configured with AI services. As such, information handling system 160 may be a “trusted peer” of information handling system 135. Thus, information handling system 160 may be available to share AI workload 115 similar to device 150. In this example, information handling system 160 may be deployed within a communication network but farther from information handling system 135 than device 150. For example, information handling systems 135 and 160 may be configured within a local area network. As such, information handling system 160 may be referred to as a “far from the box” system relative to information handling system 135. Accordingly, a computing device or information handling system that is configured within a local network similar to information handling system 160 may be deemed as far from the box relative to information handling system 135. For example, device 194 and dock 196 may also be deemed as far from the box.

FW/SW management service 162 may comprise any system, device, or apparatus configured with functionality that is similar to FW/SW management service 152. CPU 164 may comprise any system, device, or apparatus configured with functionality that is similar to CPU 136. GPU 166 may comprise any system, device, or apparatus configured with functionality that is similar to GPU 138. DNPU 168 may comprise any system, device, or apparatus configured with functionality that is similar to dNPU 140. INPU 174 may comprise any system, device, or apparatus configured with functionality that is similar to iNPU 144. Memories 170 and 172 may be configured similar to memory 148. In this example, memory 170 may be accessible by CPU 164 while memory 172 may be accessible by GPU 166. However, information handling system 160 may have more or less memories than shown. For example, information handling system 160 may have one memory that is accessible by CPU 164, GPU 166, dNPU 168, and iNPU 174.

Cloud data center 185 includes cloud gateway services 175, an information handling system 176, and an AI server 180. Cloud data center 185 may also include one or more racks that house information handling systems. In addition, other cloud data centers aside from cloud data center 185 may also be included as part of the cloud. In another embodiment, cloud gateway services 175 may be hosted by information handling system 176 or AI server 180. One or both of information handling system 176 and AI server 180 may be a physical or a virtual computing device. Cloud gateway services 175 includes a cloud workload orchestrator 184, an ITDM portal 186, a workspace reservation data store 188, IT policy 182, and applications 190 and 192. Applications 190 and 192 are applications installed remotely on cloud gateway service 175, also referred to as on-the-cloud (OTC) applications. These applications may be discrete application entities, or they may work in conjunction with OTB applications of information handling systems within the network, such as applications 102 and 104.

Cloud workload orchestrator 184 may comprise any system, device, or apparatus configured to run an AI workload on an available cloud computer, which can be in a private cloud, or a cloud computing platform based on an IT policy. ITDM portal 186 may comprise any system, device, or apparatus configured to allow an ITDM or a user to set policy on distributed system environment 100 as a whole, a set of information handling systems, or an individual information handling system. ITDM portal 186 also allows the ITDM to participate in the allocation of the information handling systems or resources in distributed system environment 100. In addition, ITDM portal 186 further allows the ITDM, user, or cloud workload orchestrator 184 to look up forthcoming workspace reservations and decide where a machine learning model, a deep learning model, an AI workload, or similar should be run.

Workspace reservation data store 188 may comprise any system, device, or apparatus configured to allow cloud gateway services 175 to store and retrieve data, such as workspace reservations. In one embodiment, workspace reservation data store 188 may be similar to data storage 108. For example, workspace reservation data store 188 may include a magnetic hard disk storage drive or a solid-state storage drive. In certain embodiments, workspace reservation data store 188 may be a cloud system of storage devices that is accessible via network. Further workspace reservation data store 188 may include a database or a collection of files that is a central repository of data associated with workspace reservations that are accessible by cloud workload orchestrator 184, ITDM portal 186, and/or applications 190 and 192. For example, cloud workload orchestrator 184 may retrieve, store, and utilize data stored in workspace reservation data store 188 via ITDM portal 186.

In modern enterprises, the term “hoteling,” shared workspaces, or co-working spaces collectively refer to physical environments where clients, users, or employees can schedule their hourly, daily, or weekly use of individual spaces, such as office desks, cubicles, or conference rooms, thus serving as an alternative to conventional, permanently assigned seating. In some cases, hoteling clients, users, or employees access a reservation system to book an individual space, such as a desk, a cubicle, a conference room, an office, etc. before they arrive at work, which gives them the freedom and flexibility to work wherever they want to. Each workspace may include its own set of peripheral devices or components, such as displays, webcams, microphones, speakers, headsets, printers, etc. When a client, user, or employee reaches the workspace, they typically bring their individual information handling system, connect their information handling system to a dock or docking station, and integrate with the set of peripheral devices or components.

Shared workspaces and computer equipment can be preconfigured based on location or utility. In today's work from home environment, employees infrequently visit office buildings. Cubicles, desks, and their accompanying computer equipment are thus shared by different employees in a hoteling arrangement. An employee can typically reserve a workspace using a portal online to select the workspace based on various factors, such as building, team locality, hardware, and length of time for usage. An example of a workspace reservation is shown below:

```
{
  “User”: “FirstName_LastName”,
  “Start_Time”: “2024/08/30 13:00:00 -05:00”
  “End_Time”: “2024/08/30 18:00:00 -5:00”
  “Country”: “United States”,
  “State”: “Texas”,
  “City”: “Austin”,
  “Office_Code”: “12345-3-1”
  “Workspace_Code”: “PS3-2-134-1”
}
```

When the employee arrives at the cubicle, desk, or other workspace, the employee's smartphone and laptop computer may be provisioned via wired or wireless network, such as WI-FI®, BLUETOOTH®, and other wireless networks serving the workspace. For example, provisioning may include FW/SW management services 152 determining whether there is an upcoming workspace reservation and whether there is an AI workload to be processed associated with the workspace reservation. The processing of the AI workload can also be triggered when the employee logs in. The devices or information handling system associated with the workspace reservation may also be pre-provisioned prior to the employee logging in. As such, the AI workload can be processed before the employee logs in. This enables optimization of the AI workload offload procedure.

IT policy 182 may comprise an IT policy or a set of IT policies that may indicate whether a given AI workload is eligible for migration, for example, based upon contextual information indicative of a level of processing required for that workload (e.g., whether an offload allowed or not allowed based upon AI processing capability, location requirement, security requirement, etc.). In one example, IT policy 182 may be a global IT policy as shown below:

```
{
  “IncludeCompute”: [“CPU”, “GPU”, “NPU”],
  “VideoWorkloads”: “Disabled”,
  “AudioWorkloads”: “Enabled”,
  “ExcludeDevicePattern”: “Intel ® iGPU*”
}
```

The above policy may enable the use of CPU, GPU, and NPU on the information handling systems included in distributed system environment 100 that the ITDM manages, such as information handling system 135 and 160, and device 150. According to this policy, video workloads would be disabled on the information handling systems and devices. However, this policy allows audio workloads. In this example, the IT policy would limit the use of the CPU, GPU, and NPU to clean up a meeting video but would allow the use of the CPU, GPU, and NPU to participate in cleaning up audio associated with the meeting.

In general, computer networks are considered to be trusted according to some rules, such as: a. by default, provisioned information handling systems under the purview of an organization's IT department are trusted by each other for many corporate information handling system users, and b. by default, multiple systems registered with the same account are considered to be trusted for non-corporate users. IT administrators have the ability to create smaller groups within their organization, such as engineering computing devices, workstations, etc. to trust other engineering computing devices or workstations, according to the organization's policy. For example, IT policy 182 may be configured as an engineering system group policy for a specific set or group of information handling systems as shown below:

```
{
  “LocalWorkloads”: {
    “Never”: {
      “ApplicationList”: [“Visual Studio ®”, “Creo ®”]
    },
    “NPUAvailable”: {
      “ApplicationList”: [“Teams ®”, “Zoom ®”, “VSCode ®”]
    }
  }
}
```

The above policy may apply to a set or group of information handling systems in an engineering domain that an ITDM manages. This policy may be configured to control when an AI workload can be run locally in one or more information handling systems in the engineering domain. In this example, local AI workloads may not be run locally if an end user is running a Visual Studio® or Creo® application. On the other hand, if the end-user is running Teams®, Zoom®, or VSCode®, then local AI workloads may run when there is a local NPU available.

In various embodiments, distributed system environment 100 may not include each of the components shown in FIG. 1. Additionally, or alternatively, distributed system environment 100 may include various additional components to those shown in FIG. 1. Furthermore, some components that are represented as separate components in FIG. 1 may in certain embodiments be integrated with other components. For example, in certain embodiments, all or a portion of the illustrated components may instead be provided by components integrated into one or more processors, such as a SOC.

Those of ordinary skill in the art will appreciate that the configuration, hardware, and/or software components of distributed system environment 100 depicted in FIG. 1 may vary. For example, the illustrative components within distributed system environment 100 are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

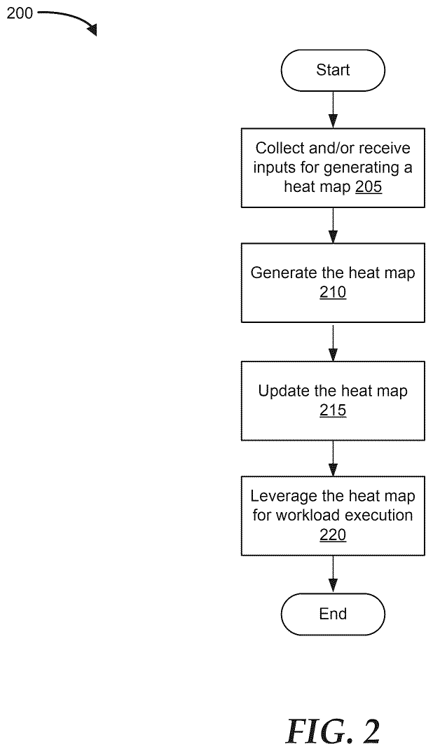

FIG. 2 illustrates a flowchart of a method 200 to dynamically direct workload execution location based on the QoS, according to an embodiment of the present disclosure. Method 200 may be performed by any suitable component of distributed system environment 100 of FIG. 1 including, but not limited to, QoS assessor 117 of FIG. 1. While embodiments of the present disclosure are described in terms of the components of distributed system environment 100 of FIG. 1, it should be recognized that other components may be utilized to perform the described method. One of skill in the art will appreciate that this flowchart explains a typical example, which can be extended to applications or services in practice. In addition, it will be readily appreciated that not every method step set forth in this flowchart is always necessary and that certain steps of the method may be combined, performed simultaneously, in a different order, or perhaps omitted, without varying from the scope of the disclosure.

Method 200 typically starts at block 205 where a QoS assessor may collect and/or receive data and/or signal inputs from one or hardware and/or software components of an information handling system. For example, data from one or more monitors in monitoring service 118 of FIG. 1 may transmit data and/or signals to QoS assessor 117 of FIG. 1. The QoS assessor may also collect and/or receive data and/or signal based on a user's work style, such as from a calendar, internet protocol address, mobility status, organization profile, etc. In addition, the QoS assessor may utilize productivity data as input, such as system load data that includes CPU load, GPU load, network consumption, memory consumption, number of open applications or documents, etc. Further, one of skill in the art will appreciate that data and/or from other sources or inputs may be utilized by the QoS assessor. The data and/or signal from the various inputs may be stored in association with a timestamp or other identifier of a time period to which the data and/or signal pertains.

Information from the inputs can indicate whether, how long, and/or the user's work mode for a particular period. The information can also indicate scheduling information, such as whether the user has scheduled meetings, whether the information handling system has a scheduled hardware scan, or similar. The inputs can indicate other information, such as how many applications are running, and a number of documents that the user has open. The QoS assessor can assign a weight to each one of the input parameters when generating the heat map. One input parameter may be given more weight compared to another input parameter. For example, thermal inputs may be given more weight compared to the user's computer activity. The weights assigned to each one of the inputs may be configurable by policy, such as IT policy 182 of FIG. 1. In addition, the policy can be configured by a system administrator and/or the user based on feedback, surveys, etc. In one embodiment, the QoS assessor could obtain or receive the inputs periodically, such as every few minutes, hourly, daily, etc.

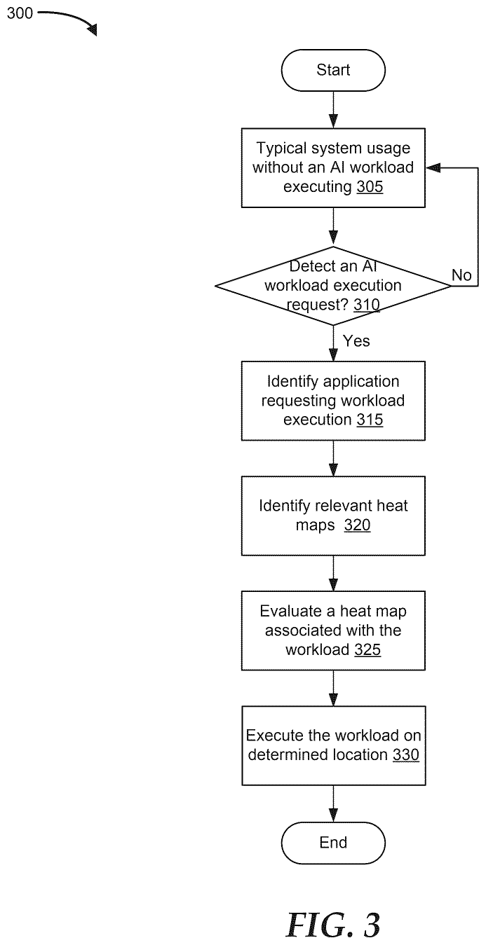

The method proceeds to block 210, wherein the QoS assessor may generate one or more heat maps, such as via a machine learning model in one example. The heat map may be generated based on various input parameters and/or QoS metrics, such as bandwidth, latency, latency variation, and error rate. The heat map may be generated for each application or workload type. In one example, the QoS assessor may generate a heat map for each OTB application. In this particular example, device 105 of FIG. 1 includes applications 102 and 104. A heat map may be generated for each one of applications 102 and 104 as depicted in FIGS. 3A and 3B. In another example, a heat map may be generated for AI workloads and another heat map may be generated for non-AI workloads. The heat map can define where to route execution of a workload, such as whether to execute the workload in the information handling system or execute the workload using an external trusted computing device, peripheral device, or information handling system.

A threshold may be used in determining whether the heat map would indicate that the workload may be executed within the information handling system or offloaded. The threshold may vary based on the day of the week and/or the time of the day. The threshold may also vary based on a priority of the application or workload. The threshold may also vary based on the productivity data of the information handling system. For example, if the information handling system is not being used at a particular time period, then the heat map may indicate that the workload can be executed within the information handling system at that time period. In another example, if the information handling system is being used at a particular time period, then the heat map may indicate that the workload may be offloaded.

The method proceeds to block 215, wherein the QoS assessor may update the heat maps based on the user's feedback and/or preferences. In one embodiment, the QoS assessor may notify a user that a workload is about to be executed and allow the user to up vote or vote down a preference, such as via Windows® notification center. For example, based on the heat map, the workload may be recommended to be executed within the box. The user may vote to continue the execution of the workload within the box. On the other hand, the user may vote to execute the workload out of the box. Similarly, when the workload is recommended to be executed out of the box, the user may vote to continue with the execution out of the box. The user may also vote to execute the workload within the box instead. In addition, the QoS assessor may update the heat map based on the user's preferences. For example, the user may prefer to always offload workloads to a docking station at 5:00 PM every work day. The user may set his preferences via a user interface associated with the QoS assessor.

In another embodiment, the QoS assessor may also update the heat map in real time based on requirements of the workload to be processed, such a computing resource requirement that further includes, processing, storage/memory, virtualization, network, etc. at that point in time. The QoS may also update the heat map based on changes in the input parameters and/or QoS metrics. For example, even if the heat map indicates that the workload should be executed within the box, the workload may be offloaded based on various factors, such as when the temperature of the information handling system exceeds a particular threshold. Similarly, even if the heat map indicates that the workload should be executed out of the box, the workload can be executed within the box if the QoS assessor detects that the information handling system is not connected to the dock. The QoS assessor may update and/or fine tune the heat map to maximize the user's QoS based on the above using one or more artificial intelligence, machine learning, and/or knowledge discovery techniques. The QoS assessor may fine tune the heat map periodically, such as daily, weekly, monthly, etc. to optimize workload execution. The QoS assessor may also reassess the heat map prior to the execution of the workload.

At block 220, the QoS assessor may leverage the heat map to determine whether to execute the workload in the information handling system or offload the execution of the workload to a docking station or another information handling system within the distributed network. Thus, the QoS assessor may utilize the heat map prior to executing the workload to determine whether to process the workload within the box or outside of the box. This is done to minimize the impact of the workload execution on the user's productivity and QoS. Accordingly, the workload may be executed based at least in part on the heat map. Afterwards, the method ends.

FIG. 3 illustrates a flowchart of a method 300 which provides a more detailed illustration of block 220 of FIG. 2. Method 300 typically starts at block 305 when a client computing device may be powered on by a user. The user may continue using the computing device typically without an AI workload running. The method may proceed to decision block 310 where an AI workload orchestrator may determine whether it detects an AI workload execution request from an application. An application may transmit a request for a workload execution to the AI workload orchestrator. If the method detects an AI workload execution request from an application, then the “YES” branch is taken, and the method proceeds to block 315. If the method does not detect an AI workload execution request from an application, then the “NO” branch is taken, and the method loops back to block 305. In one embodiment, the AI workload orchestrator may query a data store for AI workload execution requests periodically, such as every minute, every five minutes, or similar. In another embodiment, an event may be generated when the AI workload orchestrator receives a request from the application. The event may trigger the method to detect the AI workload execution request. The method may proceed to block 315.

At block 315, the AI workload orchestrator may identify the application requesting the workload execution. For example, the AI workload execution request may include information such as an application identifier, language model identifier, AI workload type, and input data, among others. AI workload type may include a data processing workload, a machine learning workload, a deep learning workload, a natural language workload, etc. The method may proceed to block 320. At block 320, a QoS assessor may identify relevant heat maps associated with the application and/or workload type. There can be more than one heat map associated with an application workload type combination. For example, a first heat map may be associated with a teleconferencing application and a data processing workload, and a second heat map may be associated with the teleconferencing application and a natural language processing workload. The method may proceed to block 325.

At block 325, the QoS assessor may evaluate a heat map from the relevant heat maps. In one embodiment, the heat map to be evaluated may be a result of a summation of the relevant heat maps. In another embodiment, the heat map to be evaluated may have been indicated by the request to execute the workload from the application, wherein the heat map is particular to the application and/or workload combination. The evaluation may result in a determination of a location to execute the AI workload, such as locally or remotely. For example, the workload may be executed within the information handling system, at a peripheral device, a docking station, a trusted information handling system in the network, or the cloud, among others. The method may proceed to block 330. At block 330, a firmware management service may direct a workload execution unit to be executed at the determined location received from the device selection service. The workload execution unit may be a CPU, a GPU, an NPU, or similar.

FIG. 4 illustrates a flowchart of a method 400 which provides a more detailed illustration of block 325 of FIG. 3. Method 400 typically starts at block 430 where the QoS assessor may perform a workload QoS scoring based on input data 405 and provide a QoS as an output. Input data 405 includes user preferences 410, past data 415, current data 420, and future data 425. The method may proceed to block 435. User preferences 410 may include whether the user preferred to offload the workload or not during work hours. The use may have provided the preference via a user interface. Past data 415 may include information from relevant heat maps, which may indicate whether the workload is typically offloaded at certain work hours. Current data 420 may include information associated with a current location of the information handling system, whether the information handling system is mobile or at a fixed location, such as a desktop, whether the information handling system is currently docked to a docking station, open applications currently running on the information handling system, current meeting status, such as whether there is a meeting currently scheduled in the user's calendar. Future data 425 may include information associated with the user's upcoming meetings based on the user's calendar. Future data 425 may also include upcoming workload executions. Further, future data 425 may include expected information for the current work day and/or time period based on past data, such as expected data usage, thermal usage, processor usage, etc. A weight may be associated with each one of user preferences 410, past data 415, current data 420, and future data 425. Input data 405 may be utilized by the QoS assessor when performing QoS scoring resulting in a QoS score. The QoS score may be used in determining a location to execute the workload by device selection device.

At block 435, a device selection service may determine where to execute the workload, such as whether to execute the workload within the information handling system or offload the workload based on the QoS score. The device selection service may further determine whether to offload the workload to a device near the information handling system, such as a peripheral device or a dock, or offload the workload to a trusted information handling system or the cloud. As such, the device selection service may provide the location as an output to block 330 of FIG. 3. A QoS score within a first threshold may indicate that the workload may be executed within the information handling system. A QoS score greater than the first threshold but within a second threshold may indicate that the workload may be offloaded.

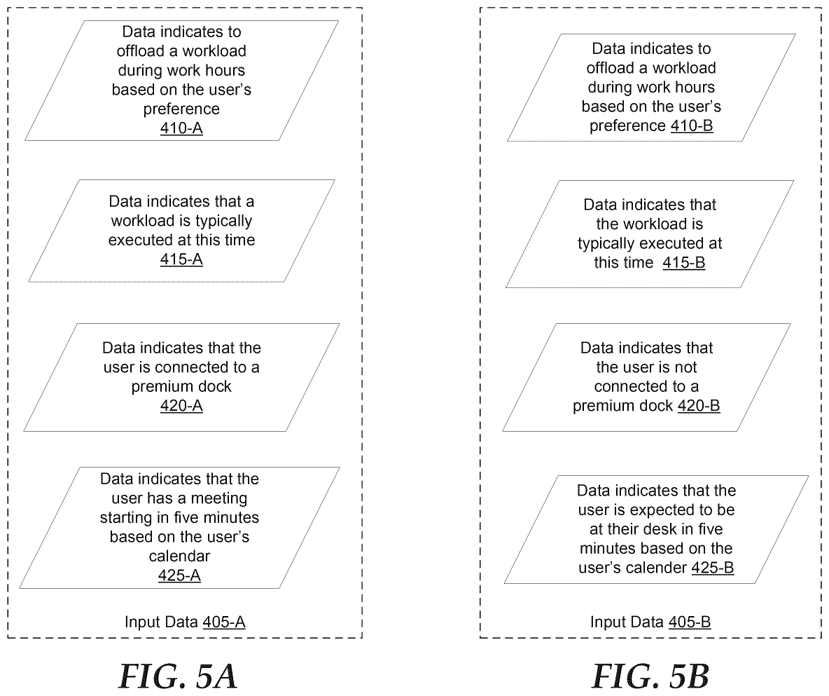

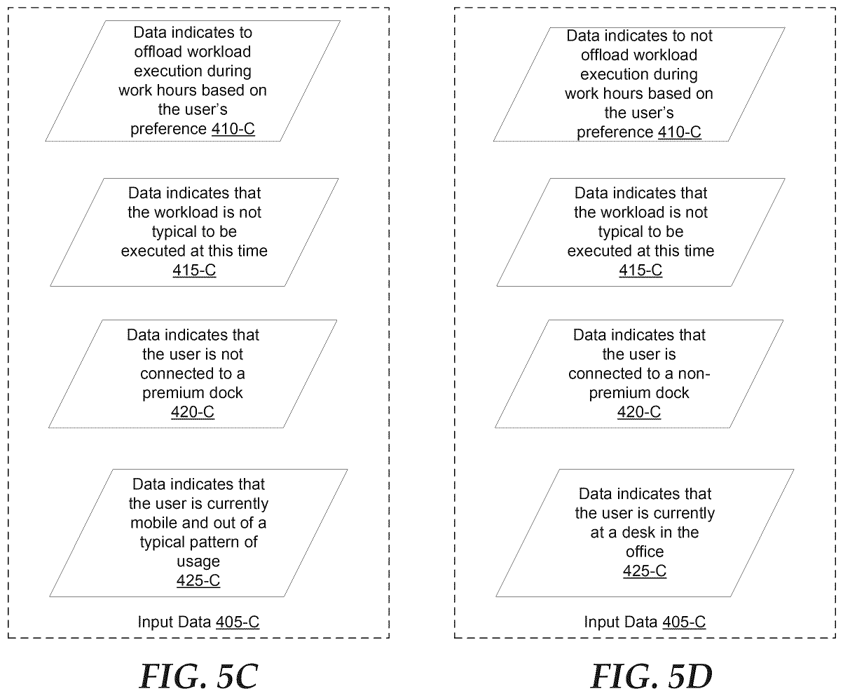

FIGS. 5A, 5B, 5C, and 5D illustrate a portion of simplified examples of input data 405, according to an embodiment of the present disclosure. FIG. 5A shows an input data 405-A that includes simplified examples of user preferences 410-A, past data 415-A, current data 420-A, and future data 425-A. User preferences 410-A may indicate that the user preference is to offload workload during work hours. Past data 415-A may indicate that a workload is typically executed at this time based on relevant heat maps. Current data 420-A may indicate that the user is connected to a docking station that is capable of executing the workload, such as a premium dock. Future data 425-A may indicate that the user has a meeting starting in five minutes based on the user's calendar. Based on input data 405-A, the device selection service may determine to offload the workload to the premium dock.

FIG. 5B shows an input data 405-B that includes simplified examples of user preferences 410-B, past data 415-B, current data 420-B, and future data 425-B. User preferences 410-B may indicate that the user preference is to offload workload during work hours. Past data 415-B may indicate that a workload is typically executed at this time based on relevant heat maps. Current data 420-B may indicate that the user is not connected to the premium docking station. Future data 425-B may indicate that the user is expected to be at a desk in five minutes based on the user's calendar. Based on input data 405-A, the device selection service may determine to hold the offload the workload to the premium dock for at least five minutes, wherein the user is expected to be at his or her desk, up to a hold time threshold. The hold may be released, wherein the workload may be offloaded when the user is detected to be connected to the premium within five minutes up to the hold time threshold.

FIG. 5C shows an input data 405-C that includes simplified examples of user preferences 410-C, past data 415-C, current data 420-C, and future data 425-C. User preferences 410-C may indicate that the user preference is to offload workload during work hours. Past data 415-B may indicate that a workload is typically not executed at this time based on relevant heat maps. Current data 420-C may indicate that the user is not connected to a premium docking station. Future data 425-C may indicate that the user is currently mobile and out of a typical pattern of usage. Based on input data 405-C, the device selection service may determine to execute the workload locally.

FIG. 5D shows an input data 405-D that includes simplified examples of user preferences 410-D, past data 415-D, current data 420-D, and future data 425-D. User preferences 410-D may indicate that the user preference is not to offload workload during work hours. Past data 415-D may indicate that a workload is typically not executed at this time based on relevant heat maps. Current data 420-D may indicate that the user is connected to a premium docking station. Future data 425-C may indicate that the user is currently at a desk in the office. Based on input data 405-D, the device selection service may determine to execute the workload locally.

FIGS. 6A and 6B illustrate a portion of a simplified example of how heat maps 600-A and 600-B respectively can be configured, according to an embodiment of the present disclosure. The heat maps may indicate whether to route execution of a workload within a client information handling system or an external computing device, such as a docking station, a peripheral device, or the cloud. In this example, heat map 600-A is associated with application 102. Heat map 600-B is associated with application 104. In one embodiment, a heat map may associate the execution of a workload of an application for a particular time period to a binary value for an optimal workload execution. In particular, the heat map may indicate whether to execute a workload within the box or outside the box. Within the box execution may refer to using a user's information handling system to execute the workload. Outside the box execution may refer to offloading the execution of the workload to an external device, such as a dock, a trusted peer information handling system, a peripheral device, or the cloud.

The heat map may refer to a two-dimensional data structure, such as a table or matrix defined through a set of at least two heat map elements. For example, the first element may be days of a work week while the second element may be a time period associated with hours of the work day. In one embodiment, the heat maps include rows of work days and columns of time periods within a work day. A workload execution unit may be referenced by a heat map row-column pair, where the workload execution unit may store a binary value to identify whether to execute the workload within the box or outside the box for each time period of the work day. For example, if the workload execution unit value is one/true, then the workload may be executed within the box. Accordingly, if the workload execution unit value is zero/false, then the workload may be executed outside the box. The workload execution unit value may be represented as visually. For example, a first color may represent a value of zero/false, while a second color may represent a value of one/true.

Heat map 600-A includes a row 610 and a column 605. An intersection of a row and column may indicate a workload execution unit value. In this example, an intersection of row 610 and column 605 shows a workload execution unit 625 with a value of true, which indicates that the workload associated with application 102 may be executed within the box on Mondays at 7:00 AM. In another example, heat map 600-B includes a row 615 and a column 620. In this example, an intersection of row 615 and column 620 shows a workload execution unit 630 with a value of false, which indicates that the workload associated with application 104, may be executed outside of the box on Mondays at 7:00 AM. When the time period changes to a next time period, the QoS assessor may revisit the heat map to determine whether the value of the workload execution unit has changed or not. For example, if the time period is hourly, at 8:00 AM on Mondays, the QoS assessor may determine a current value of the workload execution unit for that time period.

The amount of time that heat map 600-A for a particular workload encompasses can be a configurable setting. For example, an administrator could configure the QoS assessor to generate a heat map for a workload or application encompassing different time periods for optimal workload execution, such as every half hour or every two hours. One of skill in the art will appreciate that this heat map explains one example, which can be extended to other heat map elements in practice. For example, instead of depicting the work week, the heat map may depict a typical week which includes seven days. In another example, the administrator could configure the QoS assessor to generate a heat map for a set of workloads or applications. For example, the QoS assessor may generate a heat map for teleconferencing applications.

FIG. 7 illustrates an embodiment of an information handling system 700 including processors 702 and 704, a chipset 710, a memory 720, a graphics adapter 730 connected to a video display 734, a non-volatile RAM (NVRAM) 740 that includes a basic input and output system/extensible firmware interface (BIOS/EFI) module 742, a disk controller 750, a hard disk drive (HDD) 754, an optical disk drive 756, a disk emulator 760 connected to a solid-state drive (SSD) 764, an input/output (I/O) interface 770 connected to an add-on resource 774 and a trusted platform module (TPM) 776, a network interface 780, and a baseboard management controller (BMC) 790. Processor 702 is connected to chipset 710 via processor interface 706, and processor 704 is connected to the chipset via processor interface 708. In a particular embodiment, processors 702 and 704 are connected together via a high-capacity coherent fabric, such as a HyperTransport link, a QuickPath Interconnect, or the like. Chipset 710 represents an integrated circuit or group of integrated circuits that manage the data flow between processors 702 and 704 and the other elements of information handling system 700. In a particular embodiment, chipset 710 represents a pair of integrated circuits, such as a northbridge component and a southbridge component. In another embodiment, some or all of the functions and features of chipset 710 are integrated with one or more of processors 702 and 704.

Memory 720 is connected to chipset 710 via a memory interface 722. An example of memory interface 722 includes a Double Data Rate (DDR) memory channel and memory 720 represents one or more DDR Dual In-Line Memory Modules (DIMMs). In a particular embodiment, memory interface 722 represents two or more DDR channels. In another embodiment, one or more of processors 702 and 704 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 720 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 730 is connected to chipset 710 via a graphics interface 732 and provides a video display output 736 to a video display 734. An example of a graphics interface 732 includes a Peripheral Component Interconnect-Express (PCIe) interface and graphics adapter 730 can include a four-lane (×4) PCIe adapter, an eight-lane (×8) PCIe adapter, a 16-lane (×16) PCIe adapter, or another configuration, as needed or desired. In a particular embodiment, graphics adapter 730 is provided down on a system printed circuit board (PCB). Video display output 736 can include a DVI, an HDMI, a DisplayPort interface, or the like, and video display 734 can include a monitor, a smart television, an embedded display such as a laptop computer display, or the like.

NVRAM 740, disk controller 750, and I/O interface 770 are connected to chipset 710 via an I/O channel 712. An example of I/O channel 712 includes one or more point-to-point PCIe links between chipset 710 and each of NVRAM 740, disk controller 750, and I/O interface 770. Chipset 710 can also include one or more other I/O interfaces, including a PCIe interface, an Industry Standard Architecture (ISA) interface, a Small Computer Serial Interface (SCSI) interface, an I²C interface, a System Packet Interface, a Universal Serial Bus (USB), another interface, or a combination thereof. NVRAM 740 includes BIOS/EFI module 742 that stores machine-executable code (BIOS/EFI code) that operates to detect the resources of information handling system 700, to provide drivers for the resources, to initialize the resources, and to provide common access mechanisms for the resources. The functions and features of BIOS/EFI module 742 will be further described below.

Disk controller 750 includes a disk interface 752 that connects the disc controller to a hard disk drive (HDD) 754, to an optical disk drive (ODD) 756, and to disk emulator 760. An example of disk interface 752 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 760 permits SSD 764 to be connected to information handling system 700 via an external interface 762. An example of external interface 762 includes a USB interface, an institute of electrical and electronics engineers (IEEE) 1394 (Firewire) interface, a proprietary interface, or a combination thereof. Alternatively, SSD 764 can be disposed within information handling system 700.

I/O interface 770 includes a peripheral interface 772 that connects the I/O interface to add-on resource 774, to TPM 776, and to network interface 780. Peripheral interface 772 can be the same type of interface as I/O channel 712 or can be a different type of interface. As such, I/O interface 770 extends the capacity of I/O channel 712 when peripheral interface 772 and the I/O channel are of the same type, and the I/O interface translates information from a format suitable to the I/O channel to a format suitable to the peripheral interface 772 when they are of a different type. Add-on resource 774 can include a data storage system, an additional graphics interface, a network interface card (NIC), a sound/video processing card, another add-on resource, or a combination thereof. Add-on resource 774 can be on a main circuit board, on a separate circuit board, or add-in card disposed within information handling system 700, a device that is external to the information handling system, or a combination thereof.

Network interface 780 represents a network communication device disposed within information handling system 700, on a main circuit board of the information handling system, integrated onto another component such as chipset 710, in another suitable location, or a combination thereof. Network interface 780 includes a network channel 782 that provides an interface to devices that are external to information handling system 700. In a particular embodiment, network channel 782 is of a different type than peripheral interface 772 and network interface 780 translates information from a format suitable to the peripheral channel to a format suitable to external devices.

In a particular embodiment, network interface 780 includes a NIC or host bus adapter (HBA), and an example of network channel 782 includes an InfiniBand channel, a Fibre Channel, a Gigabit Ethernet channel, a proprietary channel architecture, or a combination thereof. In another embodiment, network interface 780 includes a wireless communication interface, and network channel 782 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 782 can be connected to an external network resource (not illustrated). The network resource can include another information handling system, a data storage system, another network, a grid management system, another suitable resource, or a combination thereof.

BMC 790 is connected to multiple elements of information handling system 700 via one or more management interface 792 to provide out of band monitoring, maintenance, and control of the elements of the information handling system. As such, BMC 790 represents a processing device different from processor 702 and processor 704, which provides various management functions for information handling system 700. For example, BMC 790 may be responsible for power management, cooling management, and the like. The term BMC is often used in the context of server systems, while in a consumer-level device, a BMC may be referred to as an embedded controller (EC). A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 790 can vary considerably based on the type of information handling system. BMC 790 can operate in accordance with an Intelligent Platform Management Interface (IPMI). Examples of BMC 790 include an Integrated Dell® Remote Access Controller (iDRAC).

Management interface 792 represents one or more out-of-band communication interfaces between BMC 790 and the elements of information handling system 700, and can include an Inter-Integrated Circuit (I²C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 700, that is apart from the execution of code by processors 702 and 704 and procedures that are implemented on the information handling system in response to the executed code.

BMC 790 operates to monitor and maintain system firmware, such as code stored in BIOS/EFI module 742, option ROMs for graphics adapter 730, disk controller 750, add-on resource 774, network interface 780, or other elements of information handling system 700, as needed or desired. In particular, BMC 790 includes a network interface 794 that can be connected to a remote management system to receive firmware updates, as needed or desired. Here, BMC 790 receives the firmware updates, stores the updates to a data storage device associated with the BMC, and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 790 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 790, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 790 is included on a main circuit board (such as a baseboard, a motherboard, or any combination thereof) of information handling system 700 or is integrated onto another element of the information handling system such as chipset 710, or another suitable element, as needed or desired. As such, BMC 790 can be part of an integrated circuit or a chipset within information handling system 700. An example of BMC 790 includes an iDRAC, or the like. BMC 790 may operate on a separate power plane from other resources in information handling system 700. Thus BMC 790 can communicate with the management system via network interface 794 while the resources of information handling system 700 are powered off. Here, information can be sent from the management system to BMC 790 and the information can be stored in a RAM or NVRAM associated with the BMC. Information stored in the RAM may be lost after power-down of the power plane for BMC 790, while information stored in the NVRAM may be saved through a power-down/power-up cycle of the power plane for the BMC.

Information handling system 700 can include additional components and additional busses, not shown for clarity. For example, information handling system 700 can include multiple processor cores, audio devices, and the like. While a particular arrangement of bus technologies and interconnections is illustrated for the purpose of example, one of skill will appreciate that the techniques disclosed herein are applicable to other system architectures. Information handling system 700 can include multiple central processing units (CPUs) and redundant bus controllers. One or more components can be integrated together. Information handling system 700 can include additional buses and bus protocols, for example, I²C and the like. Additional components of information handling system 700 can include one or more storage devices that can store machine-executable code, one or more communications ports for communicating with external devices, and various input and output (I/O) devices, such as a keyboard, a mouse, and a video display.

For purposes of this disclosure, information handling system 700 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 700 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 700 can include processing resources for executing machine-executable code, such as processor 702, a programmable logic array (PLA), an embedded device such as a System-on-a-Chip (SoC), or other control logic hardware. Information handling system 700 can also include one or more computer-readable media for storing machine-executable code, such as software or data.

Although FIG. 2, FIG. 3, and FIG. 4 show example blocks of method 200, method 300, and method 400 in some implementations, method 200, method 300, and method 400 may include additional blocks, fewer blocks, different blocks, or differently arranged blocks than those depicted in FIG. 2, FIG. 3, and FIG. 4. Those skilled in the art will understand that the principles presented herein may be implemented in any suitably arranged processing system. Additionally, or alternatively, two or more of the blocks of method 200 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
receiving, by a processor of an information handling system, data inputs from a plurality of computing monitors;
generating a heat map based on the data inputs from the computing monitors, wherein the heat map is generated according to a first element and a second element;
determining a location to route execution of a workload based on the heat map as indicated by a value at an intersection of the first element and the second element, wherein the location is selected between within the information handling system and an external computing device; and
routing the execution of the workload either within the information handling system or to the external computing device according to the value at the intersection.

2. The method of claim 1, wherein the data inputs include a user's computer activity.

3. The method of claim 1, wherein the first element is a work day.

4. The method of claim 1, wherein the second element is a time period within a work day.

5. The method of claim 1, further comprising updating the heat map based on a user's preference.

6. The method of claim 1, further comprising updating the heat map based on a user's feedback.

7. The method of claim 1, wherein the heat map is generated for each workload type.

8. The method of claim 1, wherein the heat map is generated for each application.

9. An information handling system, comprising:
a processor; and
a memory coupled to the processor, the memory having program instructions stored thereon that upon execution cause the processor to:
receive data inputs from a plurality of computing monitors;
generate a heat map based on the data inputs from the computing monitors, wherein the heat map is generated according to a first element and a second element;
determine a location to route execution of a workload based on the heat map as indicated by a value at an intersection of the first element and the second element, wherein the location is selected between within the information handling system and an external computing device; and
route the execution of the workload either within the information handling system or to the external computing device according to the value at the intersection.

10. The information handling system of claim 9, wherein the data inputs include a user's computer activity.

11. The information handling system of claim 9, wherein the first element is a work day k.

12. The information handling system of claim 9, wherein the second element is a time period within a work day.

13. The information handling system of claim 9, wherein the processor is further configured to update the heat map based on a user's preference.

14. The information handling system of claim 9, wherein the heat map is generated for each workload type.

15. A non-transitory computer-readable medium to store instructions that are executable to perform operations comprising:
receiving data inputs from a plurality of computing monitors;
generating a heat map based on the data inputs from the computing monitors, wherein the heat map is generated according to a first element and a second element;
determining a location to route execution of a workload based on the heat map as indicated by a value at an intersection of the first element and the second element, wherein the location is selected between within an information handling system and an external computing device; and
routing the execution of the workload either within the information handling system or to the external computing device according to the value at the intersection.

16. The non-transitory computer-readable medium of claim 15, wherein the data inputs include a user's computer activity.

17. The non-transitory computer-readable medium of claim 15, wherein the first element is a work day.

18. The non-transitory computer-readable medium of claim 15, wherein the second element is a time period within a work day.

19. The non-transitory computer-readable medium of claim 15, wherein the operations further comprise updating the heat map based on a user's preference.

20. The non-transitory computer-readable medium of claim 15, wherein the operations further comprise updating the heat map based on a user's feedback.
